(19) United States
(12) Patent Application Publication
(10) Pub. No.: US 2004/0100653 A1
(43) Pub. Date: May 27, 2004

(54) Network printer and data sharing printing system

(75) Inventor: Osamu Azami, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/637,036

(22) Filed: Aug. 8, 2003

(30) Foreign Application Priority Data
Aug. 9, 2002 (JP) P. 2002-232892

(51) Int. Cl. G06F 15/00

(52) U.S. Cl. 358/1.15; 358/1.1; 358/1.13

(57) ABSTRACT

An apparatus capable of utilizing job data or the like stored in other first printer as a first kind printer which is provided with HDD for storing job data at inside thereof and a second kind printer which is not provided with HDD, in which there is prepared an apparatus of not receiving printing instruction of what cannot be printed by its own printer without informing presence thereof to a user and a data sharing printing system is constituted by connecting the apparatus by LAN.

The present application is based on Japanese Patent Application No. 2002-232892, which is incorporated herein by reference.

### BACKGROUND OF THE INVENTION

1. Field of the Invention

The present invention relates to a network printer and a data sharing printing system.

2. Description of the Related Art

As is well known, in a network printer, there is present a printer having HDD and capable of storing job data (print data) or form data in the HDD.

When a network printer having the above-described function is used, in the case in which a certain printed matter is needed, the printed matter can be provided without transmitting job data for the printed matter from a host computer and therefore, various kinds of operation can efficiently be carried out. However, the network printer having the above-described function cannot inexpensively be fabricated since HDD is needed.

Therefore, it is considered that sharing of HDD which is carried out between computers constituting LAN is carried out between a network printer which is not provided with HDD and other apparatus (printer/computer) which is provided with HDD. However, by only constituting a network printer simply to be able to share HDD, when a number of network printers having different printing performances are connected to the same LAN, there is provided a system capable of instructing to print the job data which cannot actually be printed to the respective network printers (a system which may not carry out normal printing as in interrupting to print by bringing about error although preserved job data is instructed to print).

### SUMMARY OF THE INVENTION

Hence, it is a problem of the invention to provide a network printer capable of constructing a network system which can share printing data of job data or the like with other apparatus without any problem.

In order to resolve the above-described problem, according to the invention, there is provided a network printer used by being connected to. a computer network including one unit or more of printing data holding apparatus holding a number of printing data in a form in correspondence with information indicating by what performance of a printer respective printing data can be utilized, the network printer comprising printing means for printing on a sheet, specifying means for specifying printing data capable of being printed by the printing means from the printing data held by the printing data holding apparatus for each of the printing data holding apparatus by communicating with the one unit or more of the printing data holding apparatus, information transmitting means for transmitting information representing a result specified by the specifying means to a computer included in the computer network, and printing instruction responding means for acquiring printing data when a printing operation utilizing any of the printing data specified by the specifying means is instructed to execute from the printing data holding apparatus holding the printing data in the computer network and making the printing means execute the printing operation utilizing the printing data.

As is apparent from the above-described constitution, the network printer according to a first aspect of the invention is a printer in which even with regard to printing data held by other printing data holding apparatus (data used in printing job data, form data or the like), so far as the data cannot be printed by its own printer, printing instruction is not received without making a user know presence thereof. Therefore, when the network printer is used, there can be constructed a network system capable of sharing printing data of job data or the like with other apparatus regardless of a mode of use (even when a plurality of units of network printers having different printing performances are connected to the same LAN).

When the network printer according to a second aspect of the invention is realized, printing data storing means for storing the printing data and printing data preserving means for preserving the printing data transmitted in a form of being instructed to preserve at the printing data storing means may be added and as the printing instruction responding means, there can be adopted means for making the printing means execute the printing operation utilizing the read printing data by reading the printing data from the printing data storing means when a request for printing instructing to utilize the printing data preserved in the printing data storing means is received.

Further, the network printer according to the invention may be realized by constituting the printing data holding apparatus integrated with the network printer according to the invention as an apparatus of controlling each of the printing data held in the apparatus per se in correspondence with control information including information of identifying the printing data and attribute information indicating by what specification of the printer the printing data can be printed and adopting means for specifying the printing data capable of making the printing means execute a printing operation from the printing data held by the printing data holding apparatus by acquiring the control information from the printing data holding apparatus as the specifying means.

Further, although any means may be adopted as the information transmitting means constituting the network printer of the invention, in order that a special software may not be installed to a side of the computer, it is preferable to constitute the information transmitting means by means for providing a Web page including the information representing the result specified by the specifying means to a computer included in the computer network.

Further, in realizing the network printer of the invention, the printing data holding apparatus integrated with the network printer according to the invention may be constituted by a network printer.

Further, a data sharing printing system according to the invention is constituted by connecting a plurality of first kind network printers substantially in correspondence with the network printers according to the first aspect and second kind network printer substantially in correspondence with the network printers according to the second aspect. Therefore, the data sharing printing system functions as a network system capable of sharing with other apparatus of printing data of job data or the like without bringing about any problem even when the first kind / second kind network printers are added.

### BRIEF DESCRIPTION OF THE DRAWINGS

In the accompanying drawings:

FIG. 1 is an explanatory view of a data sharing printing system according to an embodiment of the invention;

FIGS. 2A and 2B illustrate explanatory views of a first kind printer and a second kind printer used in the data sharing printing system according to the embodiment;

FIG. 3 is an explanatory view of a job control table in other printer stored in the first kind printer and the second kind printer;

FIG. 4 is a flowchart of processings of updating a job control table executed at the first kind printer and the second kind printer;

FIG. 5 is a flowchart of processings which maybe executed at step S103 of FIG. 4;

FIG. 6 is an explanatory view of a QPJM page provided to PC by the first kind printer and the second kind printer; and

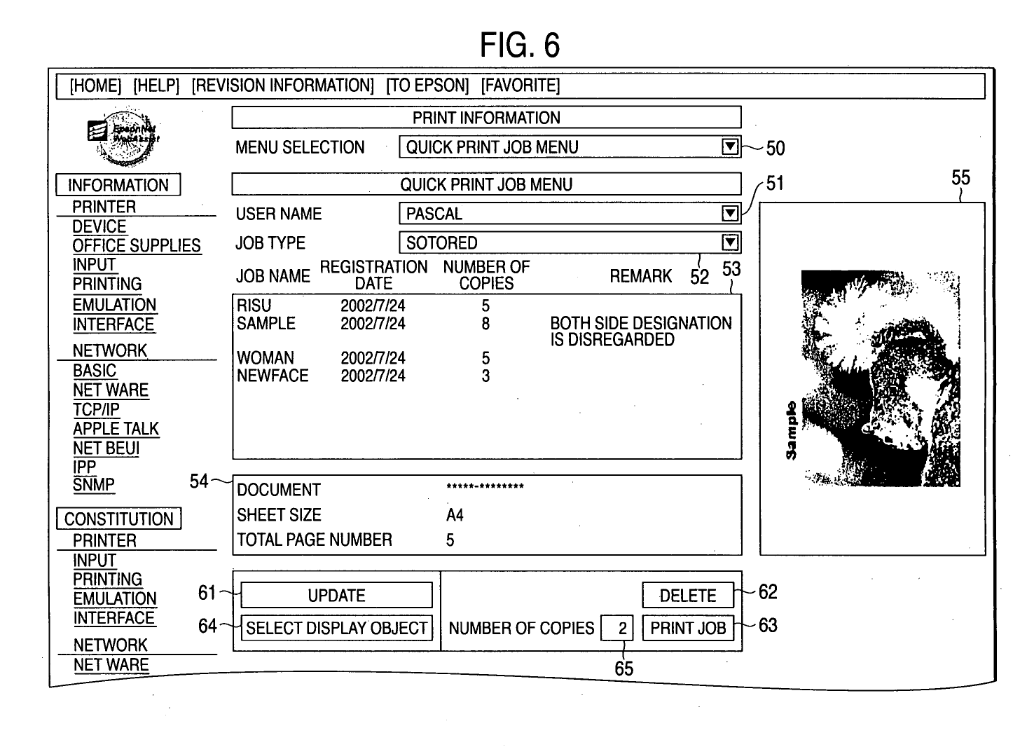

FIG. 7 is an explanatory view of a QPJM page provided to PC by the first kind printer and the second kind printer.

### DETAILED DESCRIPTION OF THE PREFERRED EMBODIMENTS

A mode for carrying out the invention will be explained in details in reference to drawings as follows.

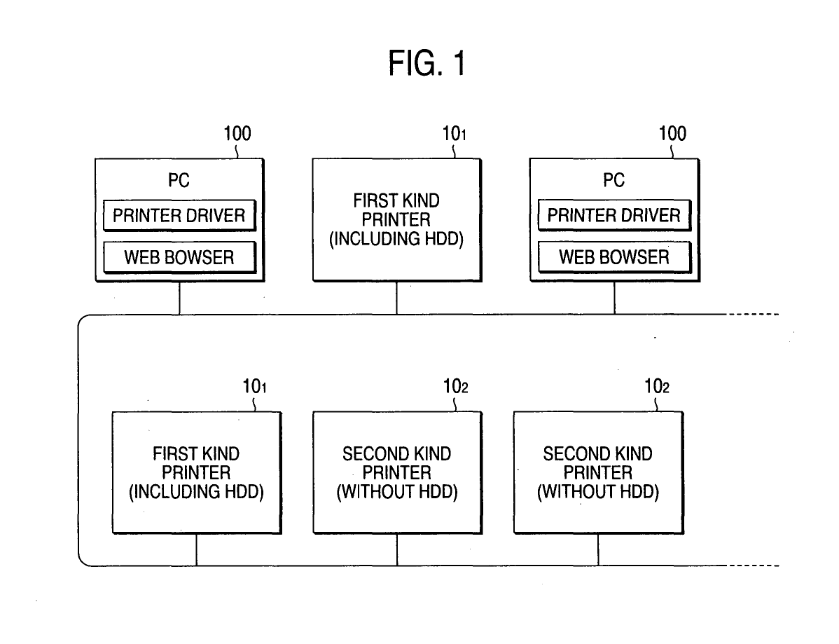

First, an outline of a data sharing printing system according to an embodiment of the invention will be explained in reference to FIG. 1.

The data sharing printing system according to the embodiment is a system of connecting pluralities of units of first kind printers 10₁/second kind printers 10₂ selected to include at least one unit of the first kind printer 10₁ from various kinds of the first kind printers 10₁/second kind printers 10₂ to the same LAN and installing a number of units of personal computers (PC) 100 connected to the LAN with printer drivers and Web browsers for any ones of the first kind printers 10₁/second kind printers 10₂.

The first kind printer 10₁ is a network printer having HDD and capable of registering reserve job data and form data to the HDD. The first kind data 10₁ is an apparatus operating without particularly changing from an existing network printer capable of registering reserve job data and the like in a state in which other ones of the first kind printers 10₁/second kindprinters 10₂ are not connected to LAN to which the apparatus per se is connected. Further, the second kind printer 10₂ is an apparatus which is not provided with HDD and therefore, cannot register reserve job data or the like in the apparatus of its own.

However, the first kind printer 10₁ and the second kind printer 10₂ are apparatus capable of constructing a system capable of making the respective first kind printers 10₁/second kind printers 10₂ carry out printing utilizing reserve job data or form data stored in other ones of the first kind printers 10₁ by being used in the form as shown by FIG. 1.

With the above-described as a premise, a specific explanation will be given of constitution and operation of the data sharing printing system according to the embodiment as follows. Further, as described above, the data sharing printing system is a system capable of sharing reserve job data and form data among printers and processings which are carried out in the first kind printers 10₁/second kind printers 10₂ for sharing the reserve job data and the processings which are carried out in the first kind printers 10₁/second kind printers 10₂ for sharing form data are essentially the same and therefore, in the following, in order to avoid the explanation from being complicated, only operation with regard to reserve job data will be explained. Further, in reserve job data capable of registering in the respective first kind printers used in the data sharing printing system, there are three kinds of reserve job data of verified job data in which printing is carried out only partially in registering, stored job data in which printing is not carried out in registering and confidential job data in which input of pass word is needed in instructing printing from an operation panel, however, an explanation of printing processing, a control procedure of pass word and the like which are carried out in registering will be omitted to avoid the explanation from being complicated.

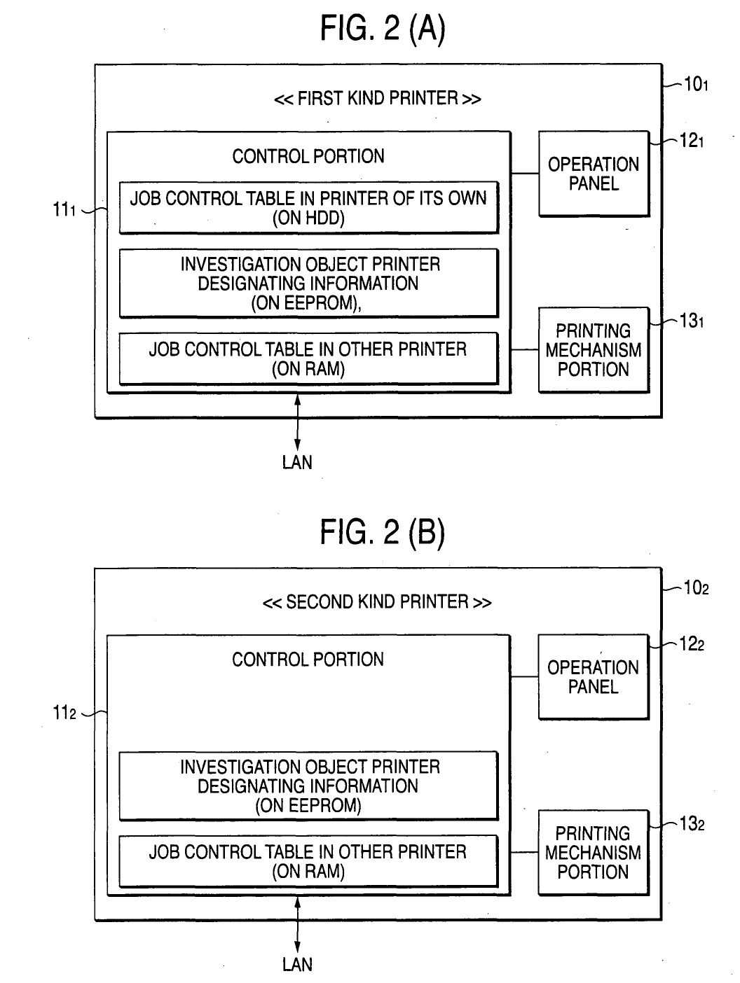

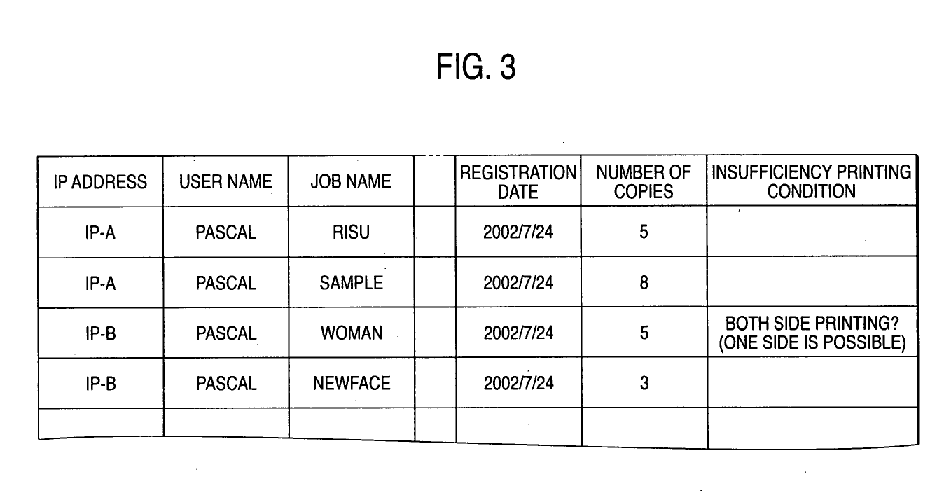

First, an explanation will be given of constitutions of the first kind printer 10₁ and the second kind printer 10₂ used in the data sharing printing system in reference to FIG. 2 and FIG. 3.

As shown by FIG. 2A, the first kind printer 10₁ is provided with a control portion 11₁, an operation panel 12₁, and a printing mechanism portion 13₁.

The operation panel 12₁ is an interface between a user and the first kind printer 10₁ (control portion 11₁). The operation panel 12₁ is constituted by several push button switches operated by the user, a liquid crystal display for displaying various kinds of messages, several light emitting diodes for showing an operational state of the first kind printer 10₁, an interface circuit between these and the control portion 11₁ and the like.

The printing mechanism portion 13₁ is a mechanism for carrying out printing in accordance with data provided from the control portion 1 on sheet and is constituted by a sheet feeding apparatus, a printing engine, a sheet discharging apparatus and the like.

The control portion 11₁ is a unit for synthetically controlling respective portions at inside of the first kind printer 10₁. The control portion 11₁ is constituted by CPU, ROM, RAM, EEPROM, HDD, a network interface circuit and the like.

The control portion 11₁ is operated in a state of storing several sets of reserve job data and thumb nail data, several form data (not illustrated) and a job control table in its own printer to HDD, storing a job control table in other printer to RAM and storing investigation object printer designating information to EEPROM.

Although a description will be given later of data of procedures of updating the job control table in its own printer, the job control table in other printer and investigation object printer designating information and the like, the job control table in its own printer is a table for storing information comprising user name, job name, job type information, application name, file name, total page number, number of copies, registration date and time and attribute information (hereinafter, designated as detailed control information) for respective reserve job data (and thumb nail data) stored in HDD. Here, the job type information is information showing that reserve job data is any of verified/stored/confidential job data. Further, the attribute information is information comprising kind name (information showing kind of its own printer), sheet size-type information showing sheet size and sheet type to be used in printing reserve job data, transfer direction information showing whether reserve job data is data for transferring in vertical direction or data for transferring in horizontal direction, resolution of reserve job data, printing mode information showing whether reserve job data is any of monochromatic/gray/color, PDL specification of reserve job data, printing method information showing a printing method to be used in printing reserve job data (both side printing, shifter printing or the like), and sheet feeding apparatus sheet discharging apparatus information showing a sheet feeding apparatus and a sheet discharging apparatus to be used in printing reserve job data and the like.

Further, as schematically shown in FIG. 3, the job control table in other printer stored in RAM is a table for storing information comprising IP address, user name, job name, job type information, application name, file name, total page number, number of copies, registration date and time, and an insufficiency condition (hereinafter, designated as simple control information). Further, the investigation object printer designating information stored in EEPROM is information comprising several (“0” piece for initial value) of IP addresses.

As shown by FIG. 2B, the second kind printer 10₂ is an apparatus provided with an operation panel 12₂ which is an interface between the user and the second kind printer 10₂, and a printing mechanism portion 13₃ for actually carrying out printing on sheet and provided with a unit which does not include HDD as the control portion 11₂ for synthetically controlling respective portions at inside of the second kind printer 10₂. Further, the control portion 11₂ of the second kind printer 10₂ is operated in a state of storing a job control table in other printer and investigation object printer designating information having constitutions the same as the above-described respectively to RAM and EEPROM.

Next, operation of the first kind printer 10₁ and the second kind printer 10₂ will be explained.

The control portion 11₁ of the first kind printer 10₁ executes processings of registering reserve job, processing for providing Web page, processing of responding to panel operation, processings of updating job control table and processings for printers as processings related to reserve job data. Although details of the respective processings will be described later, among the processings, the processings of registering reserve job and the processing for printers are processings needing HDD and the control portion 11₂ of the second kind printer 10₂ executes processings of providing Web page, processings of responding to job control table and processings of updating job control table of contents substantially the same as those executed by the control portion 11₁.

First, an explanation will be given of the content of the processings of registering reserve job data executed by the control portion 11₁. The processings of registering reserve job data are processings started when the reserve job data is transmitted from PC100.

In the processings of registering reserve job data, the control portion 11₁ executes processings of generating reserve job data and thumb nail data of an image data style (image data having low resolution) from the received reserve job data and storing the data to HDD. Further, the control portion 11₁ also executes processings of generating detailed control information which has already been explained (information comprising user name, job name, attribute information and the like) with regard to the reserve job data based on information included in the received reserve job data and adding the information to the job control table in its own printer.

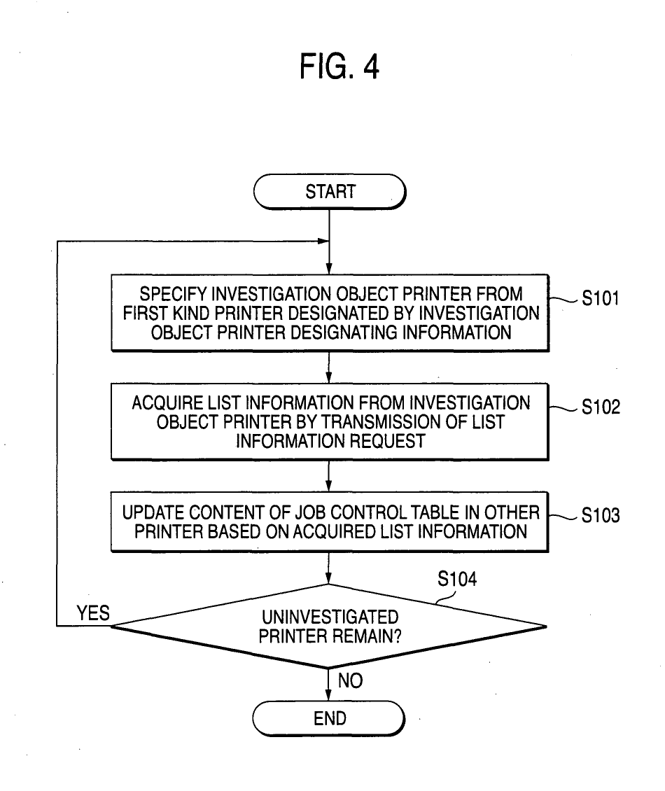

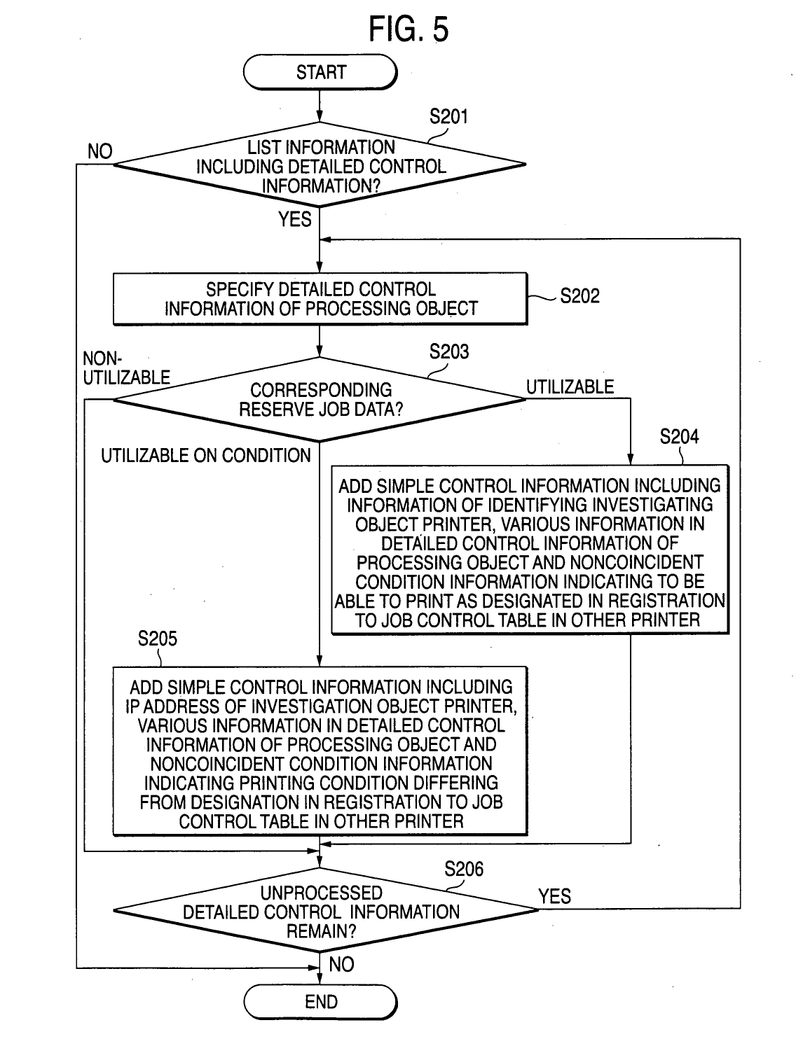

Next, an explanation will be given of operation of the control portions 11₁ and 11₂ in processings of updating job control table in reference to FIG. 4 and FIG. 5. Further, the processings of updating the job control table are processings which are executed as necessary in the processings of providing Web page and the processings of responding to panel operation explained later. Further, in the following explanation, the control portion 11₁ or the control portion 11₂ is designated as control portion 11 and the first kind printer 10₁ or the second kind printer 10₂ is designated as printer 10.

As shown by FIG. 4, in the processings of updating the job control table, first, the control portion 11 specifies one unit of the first kind printer 10₁ as an investigation object printer from the first kind printers 10₁ designated to be investigation objects by information of designating investigation object printers stored to EEPROM (step S101). Further specifically, when the investigation object printer designating information is information which does not include any unit of IP address,. the control portion 11 executes processings of specifying one unit of the first kind printer 10₁ as an investigation object printer from all of the first kind printers 10₁ connected to LAN the same as that of its own apparatus. Further, when the investigation object printer designating information includes one or more of IP addresses, the control portion 11 executes processings of specifying one unit of the first kind printer 10₁ as the investigation object printer from the first kind printers 10₁ IP addresses of which are included in the investigation object printer designating information.

Successively, the control portion 11 acquires list information from the investigation object printer by transmitting a request for list information to the investigation object printer (step S102). Here, the request for list information is a request for instructing transmission of all of detailed control information stored to the job control table in its own printer as list information or transmission of difference information showing a content of processings which have been carried out to the job control table of it own printer at and after designated date and time (addition, deletion or the like of detailed control information) as list information to the investigation object printer and when the processings of updating job control table is started in a state in which the job control table in other printer is vacant, at the step S102, the request for list information for instructing to transmit all of the detailed control information as the list information is transmitted to the investigation object printer. Further, when the processings of updating the job control table is started in a state of storing at least one piece of simple control information to the job control table in other printer, at step S102, a request for list information including information indicating date and time of executing the processings of updating the job control table at a preceding time is transmitted to the investigation object printer.

The processings for printer executed by the control portion 11 are processings for responding to a request which is transmitted from other printer and needs access to HDD as in the list information request. Further, in the processings for printer executed in receiving the request for the list information, there are carried out processings of transmitting information in accordance with the received list information request (all of detailed control information or difference information) as the list information to the printer 10 which has transmitted the list information request. Further, in requests which are processed by executing the processings for printer, other than the list information request, there are a request for thumb nail data, a request for job data, a request for deleting job data and the like, however, an explanation of content of processings for printer in response to the requests may be given later.

The control portion 11 transmitting the list information request to the investigation object printer at step S102 finishes the processing at step S102 when reception of the list information transmitted from the investigation object printer has been finished. Further, the control portion 11 executes a processing of updating a content of the job control table in other printer based on the received list information at successive step S103.

The processing which is executed at step S103 slightly differs by whether information acquired by the control portion 11 as list information is information comprising all of detailed control information or difference information.

Specifically, when the control portion 11 acquires information comprising all of detailed control information as list information, at step S103, the control portion 11 executes a procedure of processings shown in FIG. 5.

That is, first, the control portion 11 determines whether the list information acquired from the investigation object printer (hereinafter, designated as processing object list information) is information indicating that reserve job data is not registered (information which does not include even one piece of detailed control information) (step S201). Further, when the processing object list information is information in which reserve job data is not registered (step S201: NO), the control portion 11 finishes the processings of the drawing (processings at and after step S104 of FIG. 4 are started).

Meanwhile, when the processing object list information is information indicating that reserve job data is registered (information including at least one piece of detailed control information) (step S201: YES), the control portion 11 specifies first detailed control information included in the processing object list information as processing object detailed control information (step S202). Further, the control portion 11 determines whether reserve job data in correspondence with the processing object detailed control information (hereinafter, designated as corresponding reserve job data) is any one of unusable reserve job data, usable job data and usable reserve job data on condition based on attribute information (information comprising kind name, sheet size type information or the like) in the processing object detailed control information (step S203).

Here, the usable reserve job data is reserve job data capable of providing a printing result the same as that in the case of printing by the printer 10 registered with the corresponding reserve job data (reserve job data stored in the first kind printer 10₁ of a kind the same as that of its own apparatus, or reserve job data providing the same printing result although the sheet feeding apparatus/sheet discharging apparatus differ from the designated apparatus) even when printing is carried out by its own apparatus. Further, the usable reserve job data on condition is reserve job data which can be printed by its own apparatus when it is allowed that a printing condition of sheet type or printing system or the like differs from a condition designated by a registering person (reserve job data printed by one side printing when printing is carried out by its own apparatus although both side printing is instructed, or reserve job data designating a type of sheet which is not set to its own apparatus). Further, the unusable reserve job data is reserve job data which is not the usable reserve job data or the usable reserve job data on condition (reserve job data in which image data is formed in a direction which cannot be used in its own apparatus or reserve job data which needs printing on sheet of a size which cannot be printed by its own apparatus).

Further, when reserve job data in correspondence with processing object detailed control information is a usable reserve job data (step S203; usable), the control portion 11 adds simple control information comprising IP address of the investigation of this printer, various kinds of information extracted from the-processing object detailed control information and insufficiency condition (“NULL” according to the embodiment) showing that printing can be carried out as designated by the registering person to the job control table in other printer (step S204). Thereafter, the control portion 11 determines whether unprocessed detailed control information remains in the processing object list information (step S206) and when the unprocessed detailed control information remains (step S206; YES), the control portion 11 returns to step S201 and executes processing with regard to successive detailed control information.

Meanwhile, when the corresponding reserve job data is the usable reserve job data on condition (step S203; usable on condition), the control portion 11 adds simple control information comprising IP address of the processing object printer, various kinds of information extracted from the processing object detailed control information and insufficiency condition information showing a printing condition which cannot be satisfied in printing by its own apparatus to the job control table in other printer (step S205). Thereafter, the control portion 11 executes determination at step S206.

Further, when corresponding reserve job data is the unusable reserve job data (step S203; unusable), the control portion 11 executes determination at step S206 without executing any processings with regard to the job control table in other printer.

Further, when unprocessed detailed control information remains in the processing object list information (step S206; YES) the control portion 11 returns to step S201 and starts to execute processings with regard to successive detailed control information. Meanwhile, when processings for all of detailed control information in the processing object list information has been finished (step S206; NO), the control portion 11 finishes the processings of the drawing and starts processings at and after step S104 of the drawing.

As described above, according to the processing executed at step S103 by the control portion when information comprising all of detailed control information is acquired as list information, only the processing of adding simple control information to other printer control table is executed. In contrast thereto, according to the processing executed by the control portion at step S103, when difference information is acquired as list information, since the difference information is information including information comprising user name and job name with regard to respective deleted reserve job data and detailed control information with regard to added reserve job data or updated reserve job data (reserve job data registered again under the same user name and job name) the processings are processings executing not only processings of adding simple control information to other printer control table but also processings of erasing simple control information from the other printer control table and processings of rewriting simple control information stored to the other printer control table (rewrite information other than IP address, user name, job name of certain simple control information).

After executing the processing at step S103, the control portion 11 determines whether investigation with regard to all of the first kind printers 10₁ which are designated to constitute investigation objects in the investigation object printer designating information has been finished (step S104). Further, when the investigation with regard to all of the first kind printers 10₁ has not been finished (step S104; YES), the control portion 11 executes again the processings from step S101 and when the investigation with regard to all of the first kind printers 10₁ designated to be the investigation objects have been finished (step S104: NO), the processings of updating the job control table in other printer is finished.

An explanation will be given here of a content of the processings for printer with regard to the request for thumb nail data, the request for job data and the request for deleting job data.

Although an explanation of timings of outputting the requests by the printer 10 will be described later, any of the requests are requests including user name and job name, when the request for thumb nail data is received, the control portion 11₁ transmits thumb nail data at inside of HDD identified by the user name and the job name in the request for thumb nail to the printer 10 which has transmitted the request for thumb nail. Further, when the request for job data is received, the control portion 11₁ transmits reserve job data at inside of HDD identified by user name and job name in the request for job data to the printer 10 which has transmitted the request for job data. Further, when the request for deleting job data is received, the control portion 11₁ erases reserve job data identified by user name and job name included in the request for deleting job data and thumb nail data with regard thereto from HDD and delete detailed control information with regard to the reserve job data from the control table in its own printer by executing processings for printers.

Next, processings of providing Web page will be explained. Further, a difference between processings of providing Web page executed by the control portion 11₁ and processings of providing Web page executed by the control portion 11₂ is minor and therefore, in the following, the content of processings of providing Web page will be explained centering on the processings of providing Web page executed by the control portion 11₁.

The processings of providing Web page are processings capable of displaying Web page shown in FIG. 3 (hereinafter, designated as QPJM) to PC100 which has made access to its own apparatus.

The control portion 11 starts the processings of providing Web page when predetermined request from PC100 (request transmitted as a result of executing operation of inputting http://“IP address of first kind printer or second kind printer” to address bar of Web browser) is transmitted from PC100. Further, first, the control portion 11 which has started the processings of providing Web page makes PC100 which has made access to its own apparatus (hereinafter, designated as communication object PC) display predetermined Web page (hereinafter, designated as top page).

Further, when predetermined operation is executed to the top page displayed on the communication object PC, the control portion 11 makes communication object PC display Web page having a drop down list box for selecting menu (box the same as a drop down list box 50 on QPJM page) or the like. Further, when a request transmitted as a result of selecting “quid job print menu” at the drop down list box on the Web page is received, the control portion 11 executes the above-described processings of updating the job control table and thereafter forms data for QPJM page shown in FIG. 3 based on information in the control table in its own printer and the job control table in other printer (in the case of the control portion 11₂ , only information in the job control table in other printer) and transmits the data to the communication object PC.

An explanation will be given of a function of the QPJM page (operation of the communication object PC displaying the QPJM page) as follows. Further, an explanation will be given also of operation of the printer 10 with regard to various requests transmitted from the communication object PC by operating the QPJM page by the user.

A drop down list box 51 on the QPJM page is of a control capable of displaying a list of user name (not duplicated) stored in the job control table in other printer and the job control table in its own printer (in the case of QPJM page provided by the control portion 11₂, only the job control table in other printer) and selecting the user name from the list by depressing a list button. Further, a drop down list box 52 is of a control capable of displaying a list of job type information and selecting job type information from the list by depressing a list button.

A list box 53 is of a control with regard to respective simple control information/detailed control information in job control table in other printer/control table in its own printer in which information of user name and job type respectively coincide with user name shown in the drop down list box 51 and the job type information shown in the drop down list box 52 for displaying information combined with job name, registration date and time (date portion), number of copies and insufficiency condition information (hereinafter, information providing registered job) constituting elements of these. Further, the QPJM page is Web page in which display content of the list box 53 in changing to set the drop down list boxes 51 and 52 is changed without acquiring new information from the communication object printer (Web page including information of providing all of the registered jobs which have been displayed in the list box 53 at inside of data for QPJM page supplied initially from the printer).

Further, the list box 53 of a control of displaying thumb nail image with regard to reserve job data in accordance with information of providing selected registered job on a thumb nail image display region 54 when the information of providing registered job displayed at inside of the list box 53 is selected and displaying application name and file name, sheet size and total page number of the corresponding reserve job data at inside of a document information region 55.

Further specifically, when operation of selecting information of providing new registered job at inside of the list box 53 is executed, the communication object PC (Web browser) displaying the QPJM page changes various kinds of information at inside of the document information displaying region 55 in accordance with information of providing selected registered job and transmits thumb nail updating request including information showing information of providing selected registered job (hereinafter, designated as job designating information) to the communication object printer.

When the request for updating thumb nail is received, the control portion 11 at inside of the communication object printer specifies by which first kind printer 10₁, the first kind printer 10₁ stored with thumb nail data to be transmitted to the computer as a response to the request for updating thumb nail based on job designating information included in the request for updating thumb nail. Further, when the first kind printer 10₁ stored with the thumb nail data is its own apparatus, the control portion 11 executes processings of reading the thumb nail data from HDD and transmitting the data to the communication object PC. Further, only the control portion 11₁ provided at inside of the first kind printer 10₁ executes the processings with regard to the request for updating thumb nail.

Meanwhile, when the first kind printer 10₁ stored with the thumb nail data to be transmitted to the communication object PC is not its own apparatus, the control portion 11 transmits the request of thumb nail including user name and job name in accordance with job designating information to the first kind printer 10₁. As has already been explained, the control portion 11₁ at inside of the first kind printer 10₁ is constituted such that when the request for thumb nail is received, the thumb nail data identified by user name and job name included therein is read from HDD and the request for thumb nail is transmitted to the printer 10 to which the request for thumb nail is transmitted. The control portion 11 which has transmitted the request for thumb nail receives the thumb nail data and transfers the data to the communication object PC.

Further, the communication object PC which has transmitted to the request for updating thumb nail receives the thumb nail data transmitted from the communication object printer and displays an image in accordance with the thumb nail data in the thumb nail image displaying region 54.

A deletion button 62 on the QPJM page is a button to be depressed when certain reserve job data is intended to delete from HDD after the user selects information of providing registered job with regard to the reserve job data. When the deletion button 62 is depressed, the communication object PC transmits a request for executing processings of deleting job data including job designating information in accordance with information of providing selected registered job to the communication object printer.

The control portion 11 at inside of the communication object printer receiving the request for executing processing of deleting job data grasps by which data stored in which first kind printer 10₁ is constituted by reserve job data to be deleted based on job designating information included in the request for executing processing of deleting job data. Further, when the first kind printer 10₁ stored with reserve job data to be deleted is its own apparatus, the control portion 11 (in this case, the control portion 11₁) executes processings of erasing the reserve job data and thumb nail data with regard thereto and deleting detailed control information with regard to reserve job data deletion of which is instructed from the control table in its own printer.

Meanwhile, when the first kind printer 10₁ stored with reserve job data to be deleted is not its own apparatus, the control portion 11 executes processings of deleting simple control information with regard to reserve job data deletion of which has been instructed and transmitting a request for deleting reserve job data including user name and job name with regard to reserve job data deletion of which has been instructed to the first kind printer 10₁ stored with the reserve job data. At the first kind printer 10₁ receiving the request for deleting the job data, as has already been explained, there are carried out processings or erasing reserve job data identified by user name and job name included in the request of deleting job data from HDD and erasing detailed control information with regard to the reserve job data from the control table in its own printer.

Further, the control portion 11 which has executed any of the above-described processings forms again data for QPJM page for displaying QPJM page in which information of providing registered job with regard to deleted reserve job data is not shown and transmits the data to the communication object PC based on information of the job control table in other printer and in control table in its own printer (in the case of the control portion 11₂, information at inside of the job control table in other printer).

A job printing button 63 on the QPJM page is a button to be depressed by the user when reserve job data is intended to print at the communication object printer. Further, a number of copies box 65 is of a control showing a number of copies set in registering of reserve job data in accordance with information of providing selected registered job as an initial value and is of a control capable of changing the value (edit box for inputting numerical value). when the list printing button 63 is depressed, the communication object PC transmits the request for printing reserve job including job designating information in accordance with information of providing selected registered job and information of designating a number of copies showing the numerical value set at the number of copies box 65 to the communication object printer.

The control portion 11 at inside of the communication object printer receiving the request of printing reserve job determines which first kind printer 10₁ is stored with reserve job data instructed to print by the received request for printing reserve job (reserve job data shown by job designating information in the request for printing reserve job) by referring to the job control table in other printer and the job control table in its own printer and when the first kind printer 10₁ stored with the reserve job data is its own apparatus, the control portion 11 reads reserve job data from HDD and makes the printing mechanism portion 13 print based thereon by a number of copies designated by information of designating the number of copies included in the request for printing reserve job.

Further, when the first kind printer 10₁ stored with reserve job data to be printed is not its own apparatus, the control portion 11 transmits a request for job data including user name and job name of reserve job data which is needed to the first kind printer 10₁ stored with the reserve job data. As has already been explained, the first kind printer 10₁ receiving the request for job data transmits reserve job data identified by user name and job name included in the request for job data and therefore, the control portion 11 receives the reserve job data and makes the printing mechanism portion 13 execute the printing by a number of copies designated by information of designating the number of copies included in the request for printing reserve job.

An updating button 61 is a button to be depressed by the user when the content of the QPJM page is intended to be updated to the newest content. When the updating button 61 is depressed, the communication object PC transmits a request for updating including user name shown in the drop down list box 51 and information of job type shown in the drop down list box 52 to the communication object printer.

The control portion 11 in the communication object printer receiving the request for updating executes processings of updating job control table and thereafter forms source data for displaying QPJM page in which user name and job type information the same as those displayed in depressing the updating button 61 in the drop down list boxes 51 and 52 based on user name and the job type information included in the request for updating and transmits the data to the communication object PC.

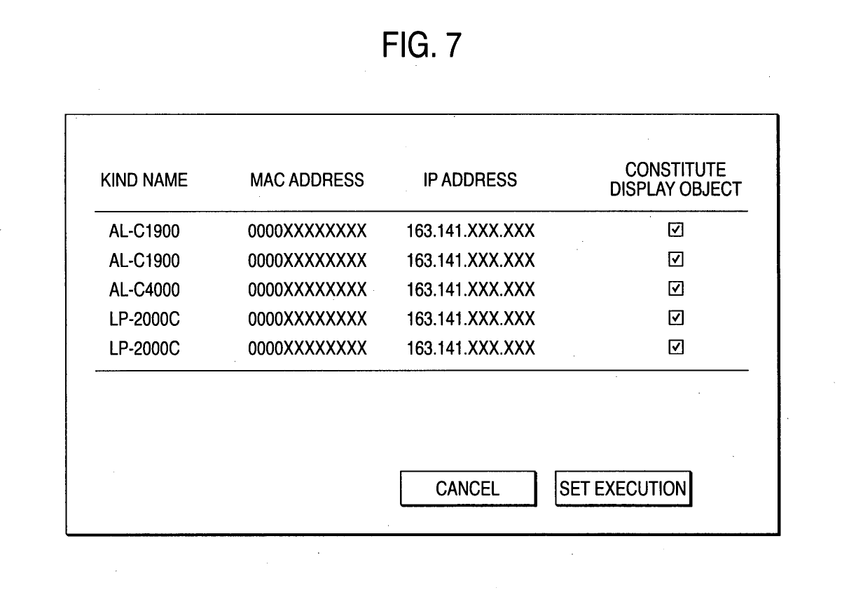

A display object selecting button 64 is a button to be depressed by the user when the first kind printer 10₁ constituting a display object of information of providing registered job is intended to designate (when the content of information of designating the investigation object printer is intended to change). When the display object selecting button 64 is depressed, at the communication object PC, there are carried out processings of transmitting a request for set page of predetermined content to the communication object printer and thereafter executing processings of displaying the page set by the investigation object printer in other window based on source data transmitted by the communication object printer receiving the request for set page. Here, as shown by FIG. 7, the investigation object printer setting page is Web page provided with a check box, a setting button or the like a state (check state/noncheck state) of which is in accordance with information of designating the investigation object printer for showing kind name, IP address or the like of each first kind printer 10₁ connected to LAN the same as that of the communication object printer and designating whether the first kind printer 10₁ constitutes an object of displaying information of providing registered job. Further, although it seems to be apparent from the constitution of the set page of the investigation object printer, when the request for set page is received, there are carried out processings of specifying IP addresses and kind names of all of the first kind printers 10₁ connected to LAN the same as that of its own apparatus and forming source data for the set page of the investigation object printer based on specified group of information and information of designating the investigation object printer and returning the data to the communication object PC.

Further, according to the communication object PC displaying the set page of the investigation object printer, there are carried processings of changing a state of the check box to a state different from the check box heretofore when certain check box on the set page of the investigation object printer is clicked. Further, when a setting execution button is depressed, there are carried out processings of transmitting a predetermined request including information of states of all of the check boxes at the time point to the communication object printer. Further, at the communication object printer receiving the request, there are carried out processings of rewriting information of designating the investigation object printer on EEPROM to information in accordance with information included in the request.

Next, an explanation will be given of processings of responding to panel operation. The processings of responding to panel operation are processings for receiving instruction of printing or instruction of deleting reserve job data from the user by way of operation with regard to push button switches on the operation panels 12₁/12₂.

Basically, operation of the control portion 11 in the processings of responding to panel operation is operation of making the user select user name and job name in this order by operating the push button switches on the operation panels 12₁/12₂ similar to the control portion in the printer capable of registering existing reserve job data and thereafter making the user designate whether reserve job data identified by the selected user name and job name is to be printed or deleted and printing/deleting the reserve job data in accordance with the designation (in printing, a number of copies can also be designated). However, whereas the control portion in the existing printer is constituted to be able to print (or delete) only reserve job data stored in its own apparatus, the control portion 11 is constituted to be able to print (or delete) reserve job data stored in other first kind printer.

Specifically, the control portion 11₁ makes the operation panel 12₁ function to be able to select either of reserve job data stored with simple control information at inside of the job control table in other printer and reserve job data stored with detailed control information at inside of the control table in its own printer in processings of responding to panel operation. Further, the control portion 11₂ makes the operation panel 12₂ function to be able to also select any one of reserve job data stored with simple control information at inside of the control table in other printer in processings of responding to panel operation. Further, with regard to reserve job data stored with simple control information including information of significant insufficiency condition, the control portions 11₁/11₂ display the job name on the liquid crystal displays of the operation panels 12₁/12₂ along with a specific sign (“!” according to the embodiment). Further, when a specific push button switch is depressed under the state, the control portions 11₁/11₂ display a message in accordance with the information of insufficiency condition on the liquid crystal displays.

Further, when certain reserve job data is instructed to print, the control portion 11 executes processings having a content the same as that in receiving a request for printing reserve job.

That is, the control portion 11 determines which first kind printer 10₁ is stored with reserve job data printing of which is instructed and when the first kind printer 10₁ stored with the reserve job data is its own apparatus, the control portion 11 reads the reserve job data from HDD and makes the printing mechanism 13 execute printing based thereon by a number of copies designated in reserve job data or by a number of copies designated by the user.

Further, when the first kind printer 10₁ stored with reserve job data to be printed is not its own apparatus, the control portion 11 transmits a request for job data including user name and job name of reserve job data which is needed to the first kind printer 10₁ stored with the reserve job data. As has already been explained, the first kind printer 10₁ receiving the request for job data transmits reserve job data identified by user name and job name included in the request for job data and therefore, the control portion 11 makes the printing mechanism portion 13 execute the printing by a number of copies designed in reserve job data or a number of copies designated by the user.

Operation of the control portion 11 when deletion of reserve job data is instructed by operation with regard to the operation panels 12₁/12₂ is the same as that when deletion of reserve job data is instructed from PC100 and therefore, an explanation thereof will be omitted.

As has been explained in details, each printer 10 (first kind printer 10₁, second kind printer 10₂) constituting the data sharing printing system according to the embodiment is constituted to specify reserve job data capable of printing by its own apparatus from reserve job data stored in other first kind printer 10, providing information with regard to only specified reserve job data to the user, further, receiving printing instruction with regard to only the specified reserve job data. Therefore, the data sharing printing system functions as a system of operating without any problem even when the printer 10 of a new kind is added or the like. Further, the data sharing printing system is a system of functioning as an apparatus having HDD (apparatus capable of printing reserve job data) although the second kind printer 10₁ is not provided with HDD and therefore, the system can be regarded to be a system having high cost performance.

### <Modified Example>

The data sharing printing system according to the embodiment can be modified variously. For example, although the above-described data sharing printing system is a system of determining whether respective reserve job data stored in other printer 10 can be printed by its own apparatus on a side of printer 10 requesting list information, there may be constituted a system in which a request for list information includes information of kind of the printer 10 transmitting the request or the like and the first kind printer 10₁ receiving the request for list information determines which of the reserve job data can be printed by the printer 10 which has transmitted the request for list information based on information of the kind included therein and informs a result thereof to the printer 10. However, when such a system is constituted, it is difficult to deal with a new kind and therefore, it is preferable to adopt the constitution of the embodiment.

Further, although the second kind printer 10₂ cannot receive reserve job data, the second kind printer 10₂ may be constituted to store reserve job data at HDD at inside of other first kind printer 10₁ or HDD at inside of PC100 when the reserve job data is received.

According to the invention, there can be provided the network printer capable of constructing the network system capable of sharing printing data of job data or the like with other apparatus without bringing about any problem regardless of a mode of use thereof (even when a plurality of units thereof having different printing performances are connected to the same LAN) and the printing data sharing system functioning as the network system.

The present invention is not limited to the above-mentioned embodiments. It can be carried out in various modes without departing from the scope of the invention.

What is claimed is:

1. A network printer which is used by being connected to a computer network including at least one printing data holding apparatus holding a number of printing data in a form in correspondence with information indicating by what performance of a printer respective printing data can be utilized, said network printer comprising:
printing means for printing on a sheet;
specifying means for specifying printing data capable of being printed by the printing means from the printing data held by each of the printing data holding apparatus by communicating with the one unit or more of the printing data holding apparatus;
information transmitting means for transmitting information representing a result specified by the specifying means to a computer included in the computer network; and
printing instruction responding means for acquiring printing data when a printing operation utilizing any of the printing data specified by the specifying means is instructed to execute from the printing data holding apparatus holding the printing data in the computer network and making the printing means execute the printing operation utilizing the printing data.

2. A network printer according to claim 1, further comprising:
printing data storing means for storing the printing data; and
printing data preserving means for preserving the printing data transmitted in a form of being instructed to preserve at the printing data storing means;
wherein when the printing instruction responding means receives a request for printing instructed to utilize the printing data held in the printing data storing means, the printing instruction responding means reads the printing data from the printing data storing means and makes the printing means execute the printing operation utilizing the read printing data.

3. A network printer according to claim 1, wherein the information transmitting means represents the result specified by the specifying means, and transmits information which can specify each of the print data stored in the printing data storing means to the computer included in the computer network to display an image on which the data to be printed is selectable.

4. A network printer according to claim 1, wherein the printing data holding apparatus is an apparatus for controlling each of the printing data held in the printing data holding apparatus per se in correspondence with control information including information of identifying the printing data and attribute information indicating by what specification of the printer the printing data can be printed; and
wherein the specifying means specifies the printing data capable of being printed by the printing means from the printing data held by the printing data holding apparatus by acquiring the control information from each of the printing data holding apparatus.

5. A network printer according to claim 1, wherein the information transmitting means is means for providing a Web page including the information representing the result specified by the specifying means to the computer included in the computer network.

6. A network printer according to claim 1, wherein the printing data holding apparatus is a network printer.

7. A data sharing printing system which is constituted by connecting a plurality of first kind network printers and a plurality of second kind network printers via a network;
wherein the second kind network printer comprises:
printing means for printing on a sheet;
specifying means for specifying printing data capable of being printed by the printing means from printing data held by each of the first kind network printers by communicating with the respective first kind network printers;
information transmitting means for transmitting information representing a result specified by the specifying means to a computer connected to the network; and
printing instruction responding means for making the printing means execute a printing operation utilizing the printing data by acquiring the printing data from the first kind network printer holding the printing data in the computer network when the printing operation utilizing any of the printing data specified by the specifying means is instructed; and
wherein the first kind network printer comprises:
printing means for printing on a sheet;
printing data storing means for storing printing data;
printing data preserving means for preserving the printing data transmitted in a form of being instructed to preserve at the printing data storing means;
means for communicating with the printer for providing information indicating what printing data is stored in the printing data storing means to the second kind network printer by communicating with the second kind network printer;
specifying means for specifying printing data capable of being printed by the printing means from the printing data held by the first kind network printer with regard to other respective first kind network printers by communicating with the other respective first kind network printers;
information transmitting means for transmitting information representing a result specified by the specifying means and transmitting information as for what printing data is stored to the printing data storing means to a computer connected to the network; and
printing instruction responding means for acquiring the printing data from the first kind network printer holding the printing data in the computer network when a printing operation utilizing any of the printing data specified by the specifying means is instructed, making the printing means execute the printing operation utilizing the printing data, reading the printing data from the printing data storing means when a printing operation utilizing any of the printing data held by the printing data storing means is instructed and making the printing means execute the printing operation utilizing the printing data.

8. A data sharing printing system according to claim 7, wherein the information transmitting means of the second kind network printer transmits information as the information representing the result specified by the specifying means, and a user can determine by the information if the print data can be printed in accordance with a designated condition.

9. A data sharing printing system according to claim 7, wherein the information transmitted by the information transmitting means of the second kind network printer is information to make the computer connected to the network display an image on which the data to be printed is selectable from the print data stored in the printing data storing means and the print data stored in each of other first kind network printers.
